(19) United States
(12) Patent Application Publication
(10) Pub. No.: US 2009/0171897 A1
(43) Pub. Date: Jul. 2, 2009

(54) METHOD AND SYSTEM FOR CASE MANAGEMENT

(76) Inventors: ULRICH SPINOLA, Weinheim (DE); Herbert Hackmann, Wiesloch (DE)

Correspondence Address: SAP AG, 3410 HILLVIEW AVENUE, PALO ALTO, CA, 94304, US

(21) Appl. No.: 11/965,806

(22) Filed: Dec. 28, 2007

(51) Int. Cl. G06F 7/10; G06F 17/30

(52) U.S. Cl. 707/3; 707/102; 707/E17.055; 707/E17.014

(57) ABSTRACT

A method and system for case management is provided. A structure hierarchy is generated based on a configuration data. The structure hierarchy has a folder node. A data object instance is associated to the folder node. A data object assembly is generated using the structure hierarchy. A task list having a task to be executed for a process is generated. A case log is generated based on an event. A case is generated by integrating the data object assembly, the task list and the case log.

### TECHNICAL FIELD

Embodiments of the invention generally relate to computer systems, and more particularly to a method and system for case management.

### BACKGROUND

In processes such as approval processes including requests, applications (for loans, scholarships and jobs), a number of processors are involved. In addition, a lot of information from different sources (like documents and business data) is required by the processors during the processing of such processes. In such cases, processors often lack an overview of the processing scenario and access to process specific information. Another limitation of such processes is that the process flow is often not clear and not well defined. In addition no specific tasks may be assigned and tracked. The communication between the processors is typically informal and not documented. This does not allow proper evaluation of the processes or future analysis and reviews.

Currently there is no software available that addresses the above problems in a generic manner and that may be reused for various implementations of the processes.

### SUMMARY OF THE INVENTION

Embodiments of the invention are generally directed to a method and system for case management. A structure hierarchy is generated based on a configuration data. The structure hierarchy has a folder node. A data object instance is associated to the folder node. A data object assembly is generated using the structure hierarchy. A task list having a task to be executed for a process is generated. A case log is generated based on an event. A case is generated by integrating the data object assembly, the task list and the case log.

These and other benefits and features of embodiments of the invention will be apparent upon consideration of the following detailed description of preferred embodiments thereof, presented in connection with the following drawings in which like reference numerals are used to identify like elements throughout

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for case management according to an embodiment of the invention.

FIG. 2 is a functional block diagram of a system for case management according to an embodiment of the invention.

FIG. 3 is a flow diagram of a process for case management according to an embodiment of the invention.

FIG. 4 is a flow diagram of a process for case management according to an embodiment of the invention.

FIG. 5 is a block diagram of a system for case management useful for implementing the invention according to an embodiment of the invention.

### DETAILED DESCRIPTION

Embodiments of the invention are generally directed to a method and system for case management. A structure hierarchy is generated based on a configuration data. The structure hierarchy has a folder node. A data object instance is associated to the folder node. A data object assembly is generated using the structure hierarchy. A task list having a task to be executed for a process is generated. A case log is generated based on an event. A case is generated by integrating the data object assembly, the task list and the case log.

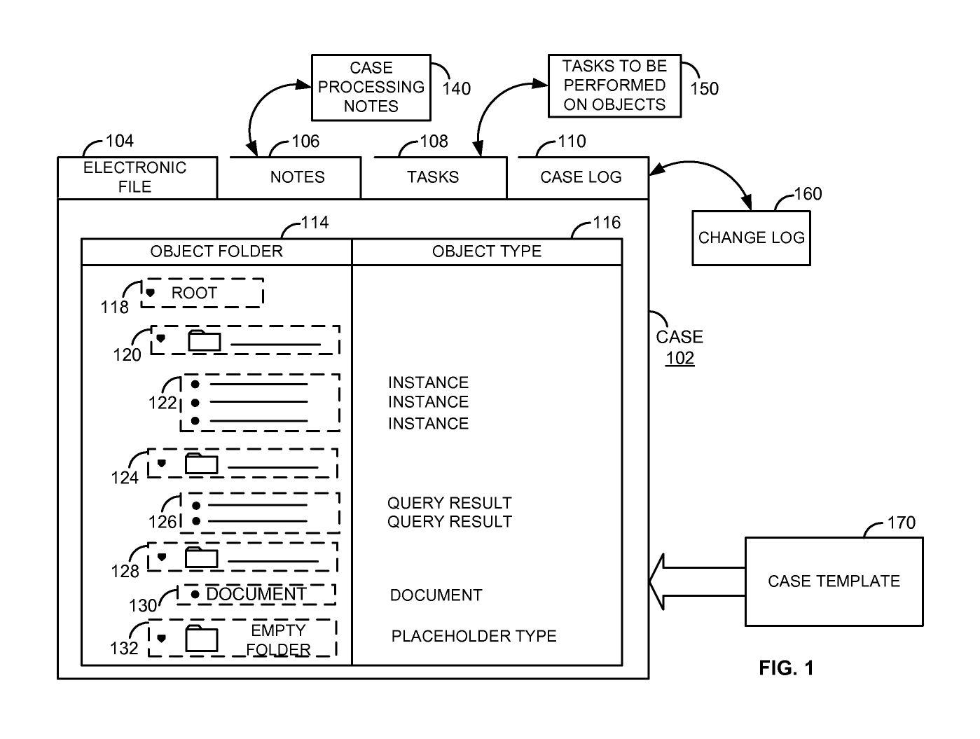

FIG. 1 is a functional block diagram of a system for case management according to an embodiment of the invention. Case 102 typically serves to actively manage, support and document context rich and incident based business processes. Case 102 facilitates both a dynamic collection of obligatory and supporting data objects and a set of tasks to be performed with often distributed responsibilities. Typical examples of cases are cases for customer requests and complaints, evaluation cases such as an engineering change case, approval processes and applications for loans, scholarships, jobs and the like. During the processing of case 102, case 102 is typically circulated among more than one processor for execution of one or more tasks allotted to the respective processor and updating of one or more case processing notes.

Case 102 includes electronic file 104, notes 106, tasks 108 and case log 110. Electronic file 104 is typically the most important component in case 102 enabling highly flexible integration of data objects relevant to case 102 and integration of document management. Electronic file 104 includes columns object folder 114 and object type 116. Object folder 114 typically provides a structure hierarchy similar to a directory structure with one or more folder nodes 118, 120, 124 and 128 arranged in a hierarchical order under root node 118. Each of the folder nodes 118, 120, 124 and 128 may be used to associate one or more data object instances as child nodes to the folder nodes. The data object instances may include information objects, documents and query results. Object type 116 indicates an object type of each data object instance in object folder 114. Data object instances 122 are data object instances associated to folder node 120. Data object instances 122 are of instance type. Data object instances 122 of instance type are typically data object instances that are selected from a list of available data object instances associable with object folder 114. In an embodiment, data object instances 122 of instance type are new data objects created by a user during a runtime. Data object instances 126 are data object instances that are associated to folder node 124. Data object instances 126 are of query result type. In an embodiment, folder node 124 is a query that is typically executed in a data object. The query, the data object and one or more query parameters that may be used for executing the query are typically configured in a business configuration. Data object instances 126 are results obtained on executing the query. In an embodiment the query is executed on the selection of folder node 124 by the user. Data object instance 130 is associated with folder node 128. Data object instance 130 is of document type and may include an information object or a document attachment. Empty folder 132 is of target placeholder type and is typically used to link data object instances at the runtime. Empty folder 132 is generally configured in the business configuration as instantiable by create or instantiable by query. If empty folder 132 is configured as instantiable by create, empty folder 132 may be used to create new data object instances for linking with object folder 114. If empty folder 132 is configured as instantiable by query, a query is typically executed in a data object typically on the selection of empty folder 132. One or more data object instances obtained as a result of executing the query are typically selected for linking to object folder 114. In an embodiment, empty folder 132 is used to generate folder nodes 120 and 128 and the corresponding data object instances 122 and 130 respectively.

Notes 106 typically include one or more case processing notes 140. Case processing notes 140 are typically text notes written by a current processor of case 102 to describe one or more tasks on case 102 and to provide directions for subsequent processors of case 102. Case processing notes 140 may also include replies to an initiator of case 102.

Tasks 108 typically include one or more tasks 150 to be performed in the processing of case 102 by the processors. Tasks 108 typically refer to one or more actions to be performed on a data object in object folder 114. In an embodiment tasks 108 are typically defined by case template 170 defined for case 102. In an embodiment case template 170 defines the hierarchical order of object folder 114.

Case log 110 is typically change log 160 and stores the changes that have been made to case 102. Case log 110 typically lists all the actions that have been executed on case 102 and the data objects linked to case 102 in object folder 114. Case log 110 is typically used for tracking and review purposes. In an embodiment, case log 110 stores one or more events. The events typically include adding a task, deleting a task, completing a task, adding a note for the case and receiving suggestions from a processor on case 102.

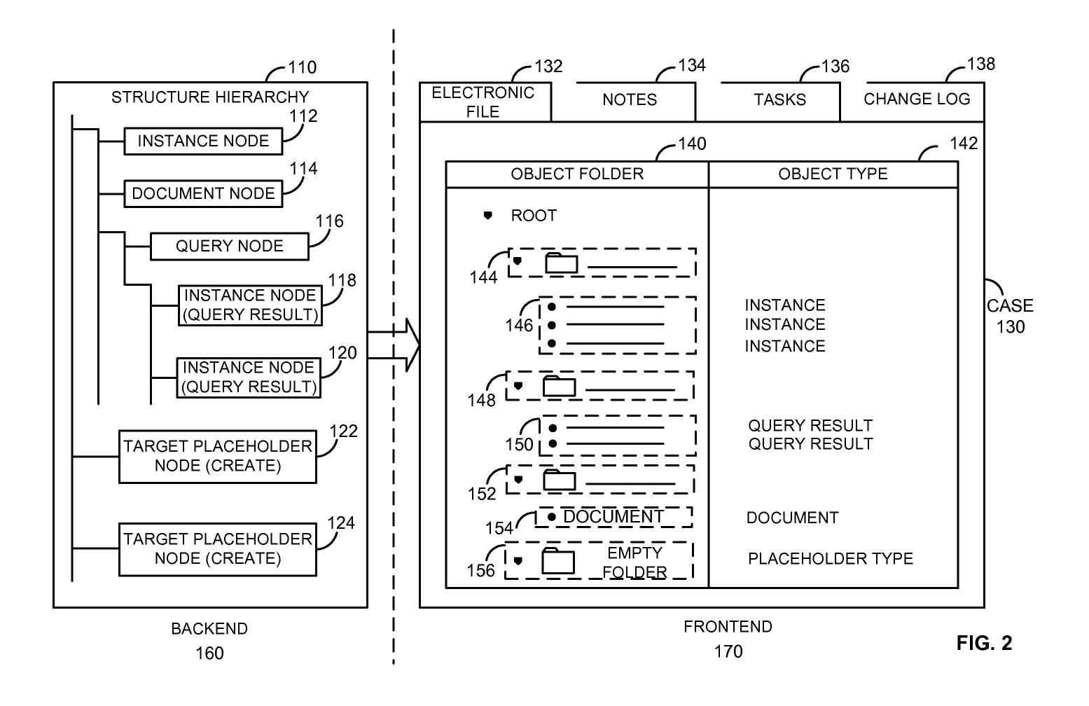

FIG. 2 is a functional block diagram of a system for case management according to an embodiment of the invention. Structure hierarchy 110 typically includes one or more folder nodes arranged in a hierarchical order. A folder node in structure hierarchy 110 may point to (or linked to) one or more data object instances, documents or a query. Structure hierarchy 110 may include folder nodes of instance type, query type, target placeholder type that are instantiable by create and target placeholder type that are instantiable by query.

Instance node 112 in structure hierarchy 110 is a folder node of instance type. Instance node 142 is typically used to link data object instances when a configuration data is generated for instance node 112 in a business configuration during a configuration time. Generating the configuration data for instance node 112 typically includes generating definitions of one or more data objects associable with structure hierarchy 110. The configuration data for instance node 112 may also include definitions of one or more data object instances associable to structure hierarchy 110 for each of the data objects. The definitions of data objects may include a data object name, a data object identifier, a short text for the data object and a customizing attribute. The short text is usually visible to a user as the name of the data object while working with structure hierarchy 110 in case 130. The definitions of data object instances may include a data object instance name, a data object instance key and a short text. The user may view the data objects and the corresponding data object instances for each data object that have the configuration data generated in the business configuration in case 130. The user may select a data object and one or more data object instances for linking with instance node 112. In an embodiment if the configuration data is not generated for instance node 112 during the configuration time, the user may configure the data objects and the data object instances during runtime using the case 130. In an embodiment, instance node 112 has a persistent character with a data object instance identifier of the data object instance linked to instance node 112 being stored in structure hierarchy 110.

Query node 116 in structure hierarchy 110 is a folder node of query type. Query node 116 may be used to execute a query in a data object. Instance nodes 118 and 120 are data object instances obtained as a result of executing the query. The query, the data object and one or more query parameters based on which the query is executed in the data object is defined as a query definition in the business configuration. In an embodiment, instance nodes 118 and 120 have a transient character with the data object instances being determined at runtime and the data object instance identifiers of the data object instances not being stored in structure hierarchy 110. The query definition for query node 116 typically includes a query name, one or more query parameters and a data object name of the data object. In an embodiment the query definition may be configured during the configuration time or the runtime.

Target placeholder node 122 in structure hierarchy 110 is a folder node of target placeholder type that is instantiable by create. Target placeholder node 122 is typically used to create new data object instances using a creation floorplan of a data object and link the new data object instances to structure hierarchy 110. A data object for target placeholder node 122 is typically configured as a configuration data in the business configuration. The configuration data of placeholder node 122 generally includes a data object name of the data object a system identifier and a client. In an embodiment, target placeholder node 122 may be configured as a wildcard node in the configuration data to enable the user to configure target placeholder node 122 during the runtime.

Target placeholder node 124 in structure hierarchy 110 is a folder node of target placeholder type that is instantiable by query. Target placeholder node 124 is typically used to execute a query on a data object, obtain one or more data object instances as a result of executing the query, selecting and linking one or more data object instances to structure hierarchy 110. The query is typically executed on the data object in a query window. The query, the data object and one or more query parameters based on which the query is executed in the data object is defined as configuration data in the business configuration. The configuration data for target placeholder node 124 typically includes a query name of the query, one or more query parameters and a data object name of the data object. In an embodiment, target placeholder node 124 may be configured as a wildcard node in the configuration data to enable the user to configure target placeholder node 124 during the runtime.

Document node 114 in structure hierarchy 110 is a folder node that is typically used to incorporate one or more documents in structure hierarchy 110. In an embodiment, one or more documents may be stored as an attachment to document node 114. In an embodiment, one or more information object instances may be linked to document node 114.

In an embodiment structure hierarchy 110 is typically used to generate a data object assembly for a required business purpose such as case 130.

Structure hierarchy 110 is typically stored in a backend 160. Structure hierarchy 110 is presented in frontend 170 as case 130. Case 130 typically provides an interface for a user to generate a data object assembly using structure hierarchy 110 to suit a business process. Electronic file 132 in case 110 generally includes folder nodes 144, 148, 152 and 156 mapped to the corresponding folder nodes in structure hierarchy 110. In an embodiment electronic file 132 has exactly one folder node for each node in structure hierarchy 110.

Folder node 144 of instance type is mapped to instance node 112 and may be used to link data object instances 146 to instance node 112. In an embodiment, the user on selecting folder node 144 is provided with a list of data objects and a corresponding data object instances for each data object that have a configuration generated in the business configuration. The user may select a data object and one or more data object instances 146 for linking with instance node 112.

Folder node 152 of document type is mapped to document node 114 and may be used to incorporate one or more documents in structure hierarchy 110 as an attachment or as information object instances.

Folder node 148 of query type is mapped to query node 116 and may be used to execute a query on a data object configured in the business configuration typically stored in backend 160. Query results 150 are mapped to instance nodes 118 and 120 and may be used to display data object instances obtained as a result of executing the query in the query window. Empty folder 156 is typically mapped either to target placeholder node 122 or target placeholder node 124 based on whether the user wants to link a data object instance by creating a new data object instance or by selecting from existing data object instances. If empty folder 156 is mapped to target placeholder node 122, empty folder 156 may be used to create and link new data object instances to target placeholder node 122. In an embodiment, the user is provided with an instance floorplan window of a business object on selecting empty folder 156 for creating new data object instances.

If empty folder 156 is mapped to target placeholder node 124, empty folder 156 may be used to link data object instances instantiable by query to target placeholder node 124. The user is typically presented with a query window on selecting empty folder 156 for executing a query on the data object. The user may then view and select one or more data object instances obtained as a result of executing the query in the query window for linking with target placeholder node 124.

In an embodiment, notes 134, tasks 136 and case log 138 are generated using structure hierarchy 110 and are linked to structure hierarchy 110 as folder nodes.

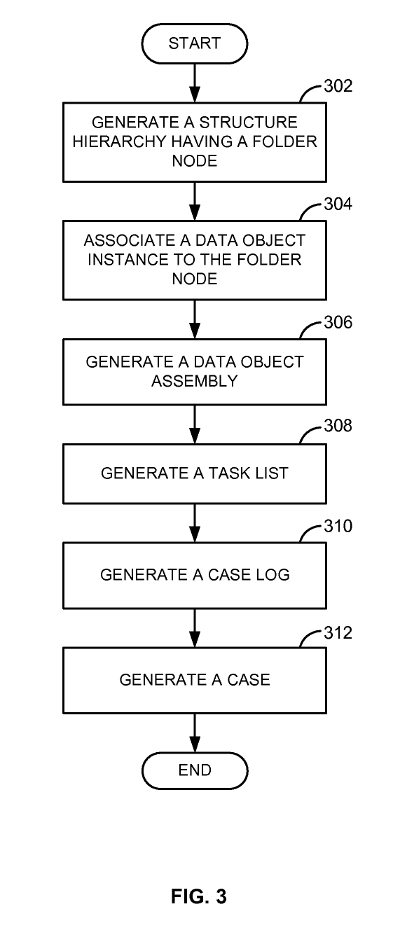

FIG. 3 is a flow diagram of a process for case management according to an embodiment of the invention. In process block 302, a structure hierarchy is generated based on a configuration data with the structure hierarchy having a folder node. The configuration data typically includes a definition of the folder node. In process block 304, a data object instance is associated to the folder node. In process block 306, a data object assembly is generated using the structure hierarchy. In process block 308, a task list having a task to be executed for a process is generated. The task typically includes one or more actions to be performed on a data object. In process block 310, a case log is generated based on an event. The case log is typically a change log and stores one or more changes that have been made to a case. The case log typically lists all the actions that have been executed on the case and the data objects linked to the case. The events typically include adding a task, deleting a task, completing a task, adding a note for the case and receiving suggestions from a processor. In process block 312, a case is generated by integrating the data object assembly, the task list and the case log.

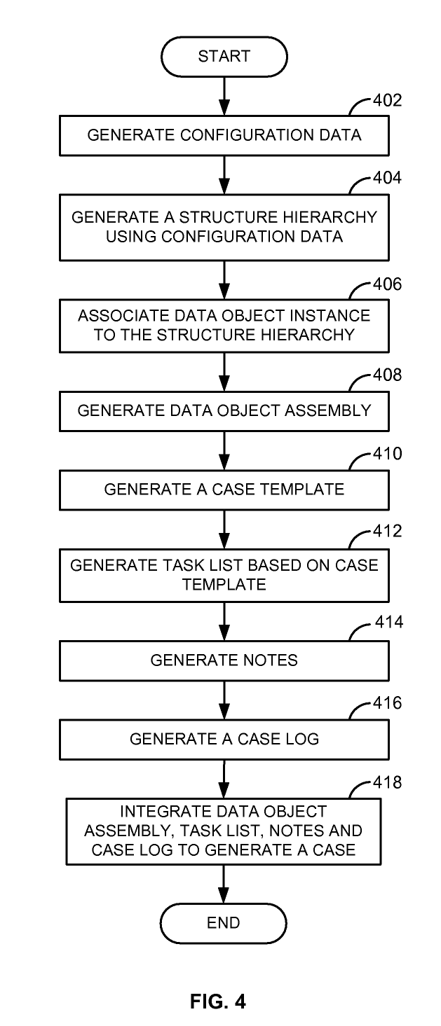

FIG. 4 is a flow diagram of a process for case management according to an embodiment of the invention. In process block 402, a configuration data is generated typically in a business configuration stored in a backend. In process block 404, a structure hierarchy is generated using the configuration data. The structure hierarchy typically includes one or more folder nodes. The structure hierarchy may be used to link data object instances to the structure hierarchy. In process block 406, one or more data object instances are associated to the structure hierarchy. In process block 408, a data object assembly is generated using the structure hierarchy typically by linking one or more data object instances to folder nodes in the structure hierarchy. In process block 410 a case template is typically generated. The case template typically defines the hierarchical order of the structure hierarchy. The case template may also include one or more tasks to be performed by one or more processors of a case. In process block 412, a task list is generated based on the case template. The task typically includes one or more actions to be performed on a data object. In process block 414, one or more notes are generated. Notes are typically case processing notes written by processors of the case typically to describe one or more tasks and to provide directions for subsequent processors of the case. In process block 416, a case log is generated. The case log is typically a change log and stores one or more changes that have been made to a case. The case log typically lists all the actions that have been executed on the case and the data objects linked to the case. The events typically include adding a task, deleting a task, completing a task, adding a note for the case and receiving suggestions from a processor. In process block 418, the data object assembly, the task list, the notes and the case log is integrated to generate a case.

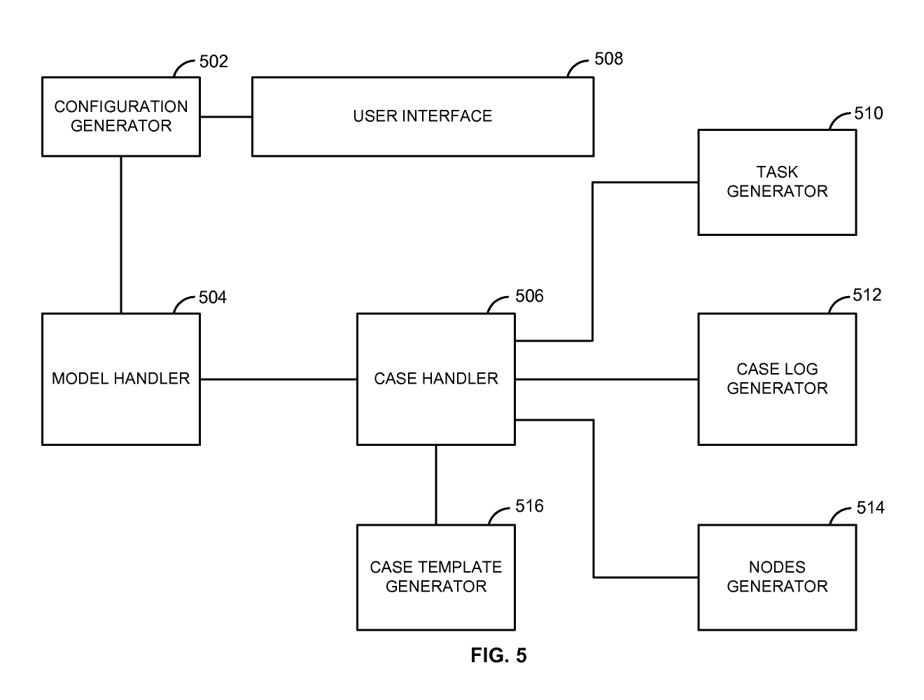

FIG. 5 is a block diagram of a system for case management useful for implementing the invention according to an embodiment of the invention. Configuration generator 102 is responsible for generating a configuration data. In an embodiment, the configuration data is generated using configuration generator 102 by a user through user interface 108. Model handler 104 is typically used to generate a structure hierarchy based on the configuration data from configuration generator 102. The structure hierarchy typically includes one or more folder nodes. Model handler may be used to link one or more data object instances to the folder nodes in the structure hierarchy. Task generator 110, case log generator 112, notes generator 114 and case template generator 116 are typically accessible to user interface 108 through case handler 106. Task generator 110 is typically responsible for generating one or more tasks for a process. The user may typically access task generator 110 through case handler 106 to generate the tasks. Case log generator 112 is typically responsible for generating a case log for the process during the processing of the process by one or more processors. The case log is typically used for tracking and review purposes. Notes generator 114 is typically responsible for generating one or more notes during the processing of the process by one or more processors. The user may typically access notes generator 114 through case handler 106 to generate one or more notes. Case template generator 116 is typically responsible for generator a case template based upon which a case may be generated. The case template typically includes a hierarchical order of the folder nodes in the structure hierarchy and one or more tasks to be performed during the processing of the tasks. Case handler 106 is typically responsible for integrating the tasks generated by task generator 110, the case log generated by case log generator 112, the notes generated by notes generator 114 to generate a case. The user may typically work on the case using user interface 108.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
generating a structure hierarchy based on a configuration data, the structure hierarchy having a folder node;
associating a data object instance to the folder node;
generating a data object assembly using the structure hierarchy;
generating a task list having a task to be executed for a process;
generating a case log based on an event; and
generating a case by integrating the data object assembly, the task list and the case log.

2. The method of claim 1 further comprising attaching a document to a second folder node in the structure hierarchy.

3. The method of claim 1 further comprising linking the task list to a second folder node in the structure hierarchy.

4. The method of claim 1 further comprising linking the case log to a third folder node in the structure hierarchy.

5. The method of claim 1 further comprising generating a case template for the structure hierarchy.

6. The method of claim 1 wherein the event is selected from a group consisting of adding a task, deleting a task, completing a task, adding a note for the case and receiving suggestions from a user.

7. The method of claim 1 further comprising:
associating a query to the folder node;
executing the query to retrieve a list of data object instances; and
select the data object instance from the list of data object instances.

8. The method of claim 1 further comprising defining a query description for the query as the configuration data.

9. The method of claim 1 further comprising generating the data object instance.

10. A system comprising:
a configuration generator for generating a configuration data;
a model handler electronically coupled to the configuration generator for generating a structure hierarchy based on the configuration data, associating a data object instance to a folder node in the structure hierarchy and generating a data object assembly using the structure hierarchy;
a task generator for generating a task list having a task to be executed for a process;
a case log generator for generating a case log based on an event; and
a case handler electronically coupled to the model handler, the task generator and the case log generator for generating a case by integrating the data object assembly, the task list and the case log.

11. The system of claim 10 further comprising a notes generator electronically coupled to the case handler for generating a note for the case.

12. The system of claim 10 further comprising a case template generator electronically coupled to the case handler for generating a case template for the case.

13. A machine-accessible medium that provides instructions that, when executed by a machine, cause the machine to perform operations comprising:
generating a structure hierarchy based on a configuration data, the structure hierarchy having a folder node;
associating a data object instance to the folder node;
generating a data object assembly using the structure hierarchy;
generating a task list having a task to be executed for a process;
generating a case log based on an event; and
generating a case by integrating the data object assembly, the task list and the case log.

14. The machine-accessible medium of claim 13 further providing instructions which when executed by the machine cause the machine to perform further operations comprising attaching a document to a second folder node in the structure hierarchy.

15. The machine-accessible medium of claim 13 further providing instructions which when executed by the machine cause the machine to perform further operations comprising linking the task list to a second folder node in the structure hierarchy.

16. The machine-accessible medium of claim 13 further providing instructions which when executed by the machine cause the machine to perform further operations comprising linking the case log to a third folder node in the structure hierarchy.

17. The machine-accessible medium of claim 13 further providing instructions which when executed by the machine cause the machine to perform further operations comprising generating a case template for the structure hierarchy.

18. The machine-accessible medium of claim 13 wherein the event is selected from a group consisting of adding a task, deleting a task, completing a task, adding a note for the case and receiving suggestions from a user.

19. The machine-accessible medium of claim 13 further providing instructions which when executed by the machine cause the machine to perform further operations comprising:
associating a query to the folder node;
executing the query to retrieve a list of data object instances; and
select the data object instance from the list of data object instances.

20. The machine-accessible medium of claim 13 further providing instructions which when executed by the machine cause the machine to perform further operations comprising defining a query description for the query as the configuration data.
